(19) United States
(12) Patent Application Publication
(10) Pub. No.: US 2015/0127482 A1
(43) Pub. Date: May 7, 2015

(54) Merchandise Recommendation System, Method and Non-Transitory Computer Readable Storage Medium of the Same for Multiple Users

(71) Applicant: Institute for Information Industry, Taipei (TW)

(72) Inventors: Grace Lin, Huailen City (TW); Meng-Jung Shih, Taoyuan County (TW); Ya-Hui Chan, Magong City (TW); Ting-Yu Lin, Kaohsiung City (TW); Yi-Hsin Wu, Taipei City (TW); Hsi-Chuan Chen, New Taipei City (TW)

(73) Assignee: Institute for Information Industry, Taipei (TW)

(21) Appl. No.: 14/096,149

(22) Filed: Dec. 4, 2013

(30) Foreign Application Priority Data
Nov. 7, 2013 (TW) 102140503

(51) Int. Cl. G06Q 30/06

(52) U.S. Cl. CPC G06Q 30/0631
USPC 705/26.7

(57) ABSTRACT

A merchandise recommendation method for multiple users used in a merchandise recommendation system including a user database, a merchandise database, a data transmission module, a processing module and a memory is provided. The merchandise recommendation method includes the steps outlined below. The processing module receives participant information and target merchandise information from a remote originator host. The processing module retrieves corresponding user information from the user database according to the participant information. The processing module retrieves corresponding merchandise information from the merchandise database according to the target merchandise information. The processing module analyzes social influence information and preference information included in the user information and analyzes the merchandise information to generate an analysis result. The processing module generates composite merchandise recommendation information according to the analysis result.

### RELATED APPLICATIONS

This application claims priority to Taiwan Application Serial Number 102140503, filed Nov. 7, 2013, which is herein incorporated by reference.

### BACKGROUND

1. Field of Invention

The present invention relates to a recommendation technology. More particularly, the present invention relates to a merchandise recommendation system, a method and a non-transitory computer readable storage medium of the same for multiple users.

2. Description of Related Art

Buying travel services and group-buying are two main commercial activities in modern life. Consequently, online websites for providing traveling and shopping information that have large databases becomes popular. It is convenient for the users to access the websites and take the information in the databases as reference.

Take buying travel services as an example, when the online resources are used to organize the trip, the information that the websites or the systems mentioned above provide is designed for a single person. However, in practical situation, there are often a multiple of participants in the trip. One of the participants may inquire of other participants' opinions, make discussion with all the participants and start to use the websites or the systems to make travel plans after the discussion. The process of discussion is time-consuming and exhausting. Likewise, if a group of participants want to buy a combination of merchandises, similar discussion has to be made to satisfy the needs of all the participants. Since the participants have their own preference respectively, the process of discussion is also time-consuming.

Accordingly, what is needed is a merchandise recommendation system, a method and a non-transitory computer readable storage medium of the same for multiple users to address the issues mentioned above.

### SUMMARY

The invention provides a merchandise recommendation system including a user database, a merchandise database, a data transmission module, a processing module and a memory. The user database stores a plurality pieces of user information. The merchandise database stores a plurality pieces of merchandise information. The processing module is coupled to the user database, the merchandise database and the data transmission module. The memory stores a plurality computer-executable commands and is coupled to the processing module. When the commands are executed by the processing module, the processing module performs the steps outlined below. A piece of participant information related to a group of participants and a piece of target merchandise information are received from a remote originator host through the data transmission module. A plurality of pieces of corresponding user information are retrieved from the user database according to the participant information. A plurality pieces of corresponding merchandise information are retrieve from the merchandise database according to the target merchandise information. A piece of social influence information included in the corresponding user information and a piece of preference information related to the corresponding merchandise information are analyzed to generate an analysis result. A piece of composite merchandise recommendation information is generated according to the analysis result.

Another aspect of the present invention is to provide a merchandise recommendation method used in a merchandise recommendation system including a user database, a merchandise database, a data transmission module, a processing module and a memory, wherein the processing module is coupled to the user database, the merchandise database, the data transmission module, the processing module and the memory. The merchandise recommendation method includes the steps outlined below. A piece of participant information related to a group of participants and a piece of target merchandise information are received from a remote originator host through the data transmission module by the processing module. A plurality of pieces of corresponding user information are retrieved from the user database according to the participant information by the processing module. A plurality pieces of corresponding merchandise information are retrieve from the merchandise database according to the target merchandise information by the processing module. A plurality of social influence information included in the corresponding user information and a piece of preference information related to the corresponding merchandise information are analyzed to generate an analysis result by the processing module. A piece of composite merchandise recommendation information is generated according to the analysis result by the processing module.

Yet another aspect of the present invention is to provide a non-transitory computer readable storage medium to store a computer program to execute a merchandise recommendation method used in a merchandise recommendation system. The merchandise recommendation system includes a user database, a merchandise database, a data transmission module, a processing module and a memory, wherein the processing module is coupled to the user database, the merchandise database, the data transmission module, the processing module and the memory. The merchandise recommendation method includes the steps outlined below. A piece of participant information related to a group of participants and a piece of target merchandise information are received from a remote originator host through the data transmission module by the processing module. A plurality of pieces of corresponding user information are retrieved from the user database according to the participant information by the processing module. A plurality pieces of corresponding merchandise information are retrieve from the merchandise database according to the target merchandise information by the processing module. A social influence information included in the corresponding user information and a piece of preference information related to the corresponding merchandise information are analyzed to generate an analysis result by the processing module. A piece of composite merchandise recommendation information is generated according to the analysis result by the processing module.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a merchandise recommendation system in an embodiment of the present invention;

FIG. 2A is a diagram of the preference values related to different merchandises of users in an embodiment of the present invention;

FIG. 2B is a diagram illustrating the social influence between the users in an embodiment of the present invention;

FIG. 3 is a block diagram of the merchandise recommendation system in an embodiment of the present invention;

FIG. 4 is a block diagram of the merchandise recommendation system in an embodiment of the present invention; and

FIG. 5 is a flow chart of a merchandise recommendation method in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

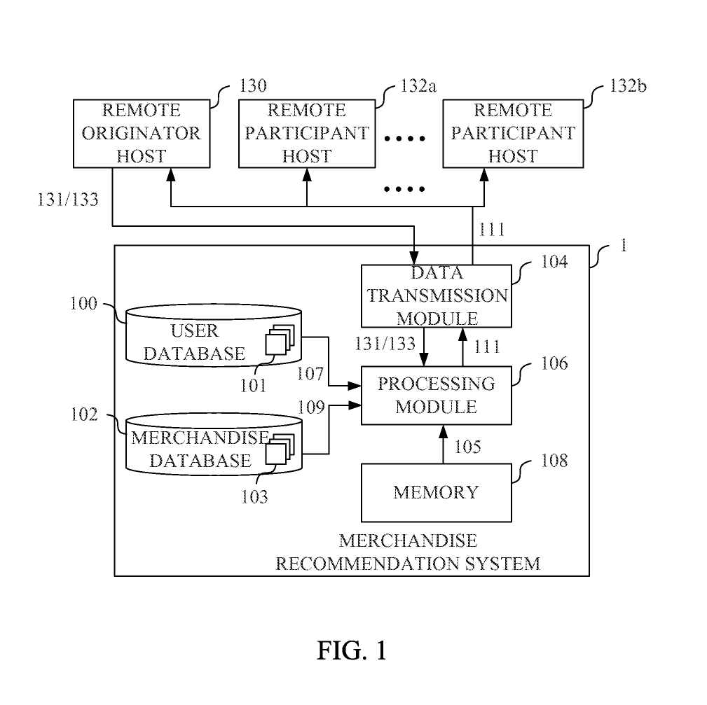

FIG. 1 is a block diagram of a merchandise recommendation system 1 in an embodiment of the present invention. The merchandise recommendation system 1 includes a user database 100, a merchandise database 102, a data transmission module 104, a processing module 106 and a memory 108.

The user database 100 stores a plurality pieces of user information 101. In an embodiment, the user information 101 includes user names, user-related profiles, social information and history records related to the merchandises. The user-related profile includes such as, but not limited to the alma mater, the occupation, the title and the hobbies of the user. The social information includes such as, but not limited to social activities and friends of the user. In different embodiments, the user information 101 includes data manually inputted by the users, the interactive data of the users in a social network website, and the history records of surveying and purchasing the merchandises.

The merchandise database 102 stores a plurality pieces of merchandise information 103. In an embodiment, if the merchandises that the merchandise recommendation system 1 recommends are related to traveling, the merchandise information 103 may include such as, but not limited to a piece of sightseeing spot information, a piece of traffic information, a piece of board and lodging information or a combination of the above. In another embodiment, if the merchandises that the merchandise recommendation system 1 recommends are related to food, the merchandise information 103 may include such as, but not limited to pineapple cakes from a first brand, egg rolls from a second brand, cookies from a third brand or a combination of the above. It is noted that, the merchandise information 103 may include other types of merchandises depending on practical demands and is not limited to the exemplary merchandises mentioned above.

The data transmission module 104 can be any module that provides an interface for the processing module 106 to communicate to other devices, such as but not limited to wired or wireless network data transmission module. The data transmission can be performed by using any possible form or specification of network communication.

The processing module 106 is coupled to the user database 100, the merchandise database 102 and the data transmission module 104. The processing module 106 can be any processor that has the ability to perform data operation. The processing module 106 performs data transmission with the databases and the modules described above by using different types of data transmission paths. In different embodiments, the memory 108 can be such as, but not limited to a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains. The memory 108 stores a plurality of computer-executable commands 105 and is coupled to the processing module 106. The processing module 106 is able to execute the commands 105 to perform and provide the functions of the merchandise recommendation system 1. The operations of the processing module 106 during the execution of the commands 105 are described below.

The processing module 106 receives a piece of participant information 131 related to a group of participants and target merchandise information 133 from a remote originator host 130 through the data transmission module 104. Take the merchandises related to traveling as an example, the remote originator host 130 is operated by an originator to transmit the participant information 131 and the target merchandise information 133. The participant information 131 includes the user names of the participants or other related information. In an embodiment, the originator is also one of the participants. The target merchandise information 133 includes such as, but not limited to the sightseeing spots, the transportations, the places for boarding and lodging or a combination of the above.

The processing module 106 retrieves pieces of corresponding user information 107 from the user database 101 according to the participant information 131. Further, the processing module 106 retrieves corresponding merchandise information 109 from the merchandise database 102 according to the target merchandise information 133. The corresponding user information 107 is the user information of the participants mentioned above. The corresponding merchandise information 109 is the merchandise information related to the target merchandise information 133.

The processing module 106 further analyzes social influence information included in the corresponding user information 107 and preference information related to the corresponding merchandise information 109 to generate an analysis result. Subsequently, the processing module 106 generates composite merchandise recommendation information 111 according to the analysis result. In an embodiment, the processing module 106 transmits the composite merchandise recommendation information 111 to remote participant hosts 132a and 132b corresponding to the group of participants through the data transmission module 104. As described above, in some embodiments, the processing module 106 also transmits the composite merchandise recommendation information 111 to the remote originator host 130 since the originator can also be one of the participants.

It is noted that the number of the remote participant hosts can be different depending on the practical condition and is not limited to the embodiment illustrated in FIG. 1.

Consequently, the merchandise recommendation system 1 of the present invention can integrate the user information of a multiple of participants and the related target merchandise information to generate the composite merchandise recommendation information that matches the demands of the multiple participants.

For example, if a user A invites a user B to travel to the west coast of United States, the user A is supposed to be the originator that sends the participant information 131 and the target merchandise information 133 to the merchandise recommendation system 1. The participant information 131 includes the user name and the related information of the user A and the user B. The target merchandise information 133 may include such as, but not limited to the sightseeing spots in the west coast such as the Space Needle in Seattle, the Disney Land in Los Angles or the Alcatraz Island in San Francisco, or the information of the airline companies, shuttle buses, hotels or restaurants.

The processing module 106 retrieves the corresponding user information 107 and the corresponding merchandise information 109 and performs analysis thereon. The analysis result of the corresponding user information 107 may show that the user A likes amusement fields and cultural spots, prefers activities that cost less money but does not like music performances. Further, the user A requires a high standard of boarding and lodging conditions. On the other hand, the analysis result of the corresponding user information 107 may show that the user B likes cultural spots and music performances but hates amusement fields. Further, the user B does not care about the cost but has no special requirement of boarding and lodging conditions. The processing module 106 calculates the preference value of the user related to each of the corresponding merchandise information 133 to further select the target merchandises that match the needs of both the user A and the user B to generate the composite merchandise recommendation information 111. In an embodiment, the processing module 106 also analyzes the correlation of the corresponding merchandise information 109, such as the distances between each of the sightseeing spots and the time that the user may stay in the sightseeing spots, to generate the composite merchandise recommendation information 111 that is arranged in a time schedule form.

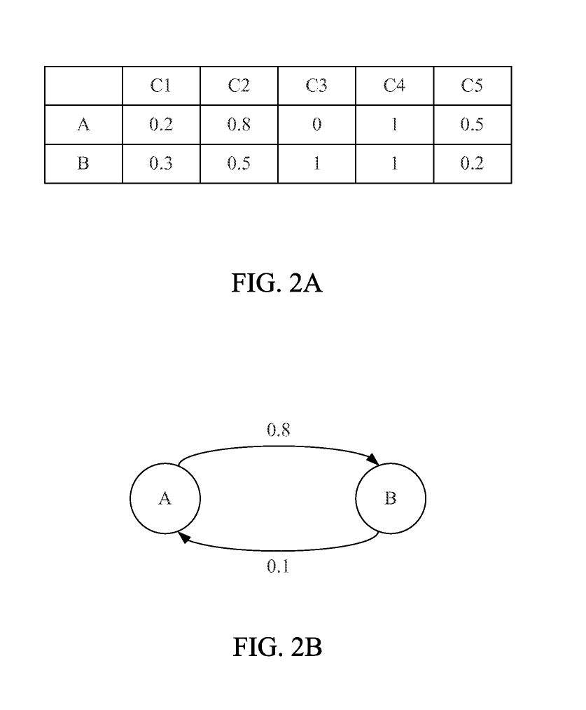

FIG. 2A is a diagram of the preference values related to different merchandises C1, C2, C3, C4 and C5 of the user A and the user B in an embodiment of the present invention. FIG. 2B is a diagram illustrating the social influence between the user A and the user B in an embodiment of the present invention.

The preference values related to the merchandises C1, C2, C3, C4 and C5 of the user A are 0.2, 0.8, 0, 1 and 0.5 respectively, as illustrated in FIG. 2A. The preference values related to different merchandises C1, C2, C3, C4 and C5 of the user B are 0.3, 0.5, 1, 1 and 0.2 respectively, as illustrated in FIG. 2A. In the present embodiment, the processing module 106 further takes the social influence illustrated in FIG. 2B into consideration, such that the social influence is used as a weighting factor to calculate the weighted preference values to match the needs of the user A and the user B. In different embodiments, the parameters of the social influence are either inputted by the originator or are obtained according to the social relation of the participants (e.g. the user A and the user B in the present embodiment). For example, if the user A and the user B are a couple and the interactions on the social network websites show that the user B mostly agrees with the decisions made by the user A, and the user A seldom agrees with the decisions made by the user B, the processing module 106 determines that the user A has a greater social influence over the user B.

In the example illustrated in FIG. 2B, the social influence of the user A over the user B is 0.8, and the social influence of the user B over the user A is 0.1. The social influence of a user to his/her own is 1. Therefore, the influence weighting parameter of the user A is calculated as (1+0.8)/2=0.9, and the influence weighting parameter of the user B is (1+0.1)/2=0.55.

Before the factor of the social influence is taken into consideration, the processing module 106 directly averages the preference values related to the merchandises C1, C2, C3, C4 and C5 of the user A and the user B shown in FIG. 2A and obtains the values of 0.25, 0.65, 0.5, 1 and 0.35. After the factor of the social influence is taken into consideration, the processing module uses the influence weighting parameters of 0.9 and 0.55 of the user A and the user B respectively to calculate weighted preference values of 0.24, 0.69, 0.38, 1.2 and 0.39. The composite merchandise recommendation information 111 is further generated according to the weighted preference values.

Accordingly, after the factor of the social influence is taken into consideration, the merchandise recommendation system 1 generates the composite merchandise recommendation information with high efficiency and high accuracy to match the needs of the participants.

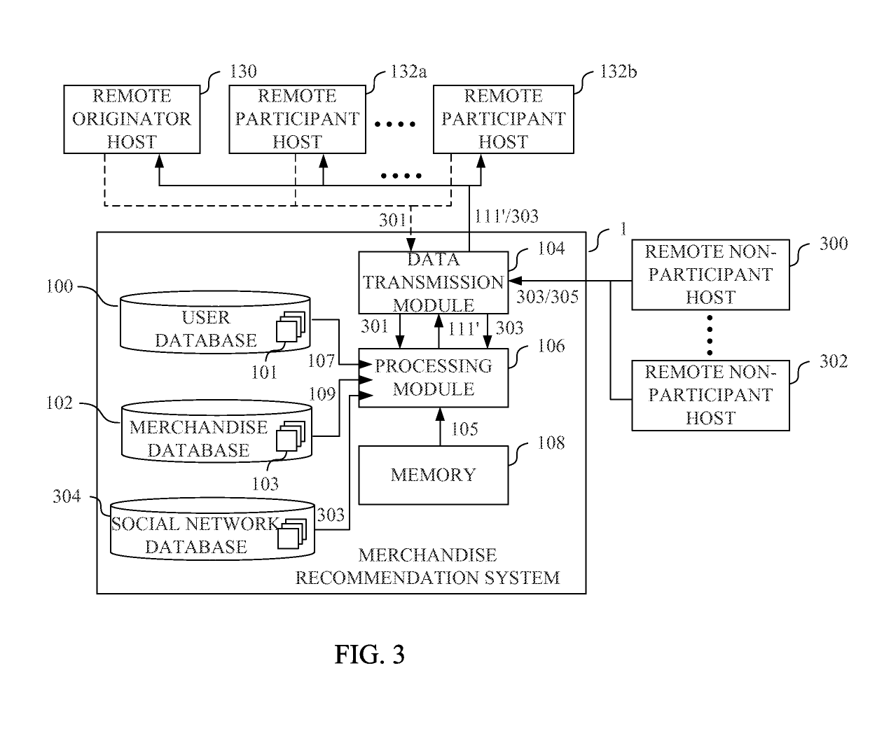

FIG. 3 is a block diagram of the merchandise recommendation system 1 in an embodiment of the present invention. Similar to the merchandise recommendation system 1 illustrated in FIG. 1, the merchandise recommendation system 1 illustrated in FIG. 3 includes a user database 100, a merchandise database 102, a data transmission module 104, a processing module 106 and a memory 108.

In the present embodiment, the processing module 106 receives editing information 301 from one of the hosts corresponding to the group of the participants through the data transmission module 104 to edit the composite merchandise recommendation information 111. In an embodiment, the processing module 106 further transmits the edited composite merchandise recommendation information 111′ to each of the participants through the data transmission module 104.

The processing module 106 further receives suggestion information 303 from remote non-participant hosts 300 and 302 corresponding to the users not in the group of participants through the data transmission module 104. The processing module 106 further transmits the suggestion information 303 to the remote participant hosts 132a and 132b. In another embodiment, the suggestion information 303 is retrieved from a social network database 304 included in the merchandise recommendation system 1 by the processing module 106.

For example, if a user that is not one of the participants surveys the composite merchandise recommendation information 111 and thinks that part of the schedule costs too much, takes too much time or brings bad memory according to its experience, the user can send the suggestion information 303 such that the participants can take the suggestion information 303 into consideration. On the other hand, the processing module 106 may retrieve the suggestion information 303 from related forum in the social network database 304 according to the keywords in the composite merchandise recommendation information 111 such that the participants can take the suggestion information 303 into consideration. Subsequently, the participants can edit the composite merchandise recommendation information 111 by transmitting the editing information 301 mentioned above.

In an embodiment, the processing module 106 receives application information 305 from the remote non-participant hosts 300 and 302 that do not correspond to the group of participants through the data transmission module 104 after the participants confirm the composite merchandise recommendation information 111. The users that are not in the group of participants are allowed to purchase the merchandises.

It is noted that the number of the remote non-participant hosts is merely an example. In other embodiments, the number of the remote non-participant hosts can be adjusted according to the practical condition. Further, the social network database is not limited to the database included in the merchandise recommendation system 1. In some embodiments, the suggestion information 303 can be retrieved from external social network databases.

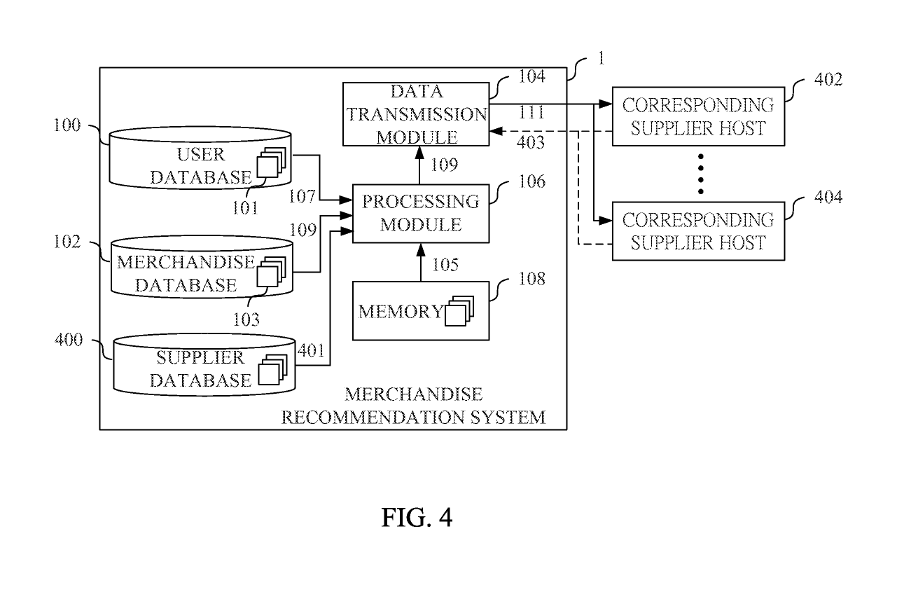

FIG. 4 is a block diagram of the merchandise recommendation system 1 in an embodiment of the present invention. Similar to the merchandise recommendation system 1 illustrated in FIG. 1, the merchandise recommendation system 1 illustrated in FIG. 4 includes a user database 100, a merchandise database 102, a data transmission module 104, a processing module 106 and a memory 108.

In the present embodiment, the processing module 106 retrieves corresponding supplier information 401 from a supplier database 400 included in the merchandise recommendation system 1 according to the composite merchandise recommendation information 111. The processing module 106 further transmits the composite merchandise recommendation information 111 to corresponding supplier hosts 402 and 404 through the data transmission module 104 according to the corresponding supplier information 401. The processing module 106 further receives competitive bidding information 403 from the corresponding supplier hosts 402 and 404 through the data transmission module 104 and selects a matched supplier according to the competitive bidding information 403 and the corresponding user information 107.

For example, the processing module 106 retrieves the corresponding supplier information 401 of the suppliers that is able to provide the merchandises such as, but not limited to travel agencies or private tour guides according to the sightseeing spot information or the boarding and lodging information in the composite merchandise recommendation information 111. The processing module 106 transmits the composite merchandise recommendation information 111 to the corresponding supplier hosts 402 and 404 of theses suppliers and selects the matched supplier according to the competitive bidding information. In different embodiments, the matched supplier can be selected according to such as, but not limited to the quality or the cost of the merchandises.

It is noted that the number of the corresponding supplier hosts can be different depending on the practical condition and is not limited to the embodiment illustrated in FIG. 4.

Accordingly, the merchandise recommendation system 1 not only generates the composite merchandise recommendation information 111 to match the needs of the participants, also provides a supplier-selecting mechanism. The efficiency and accuracy of the recommendation is further increased.

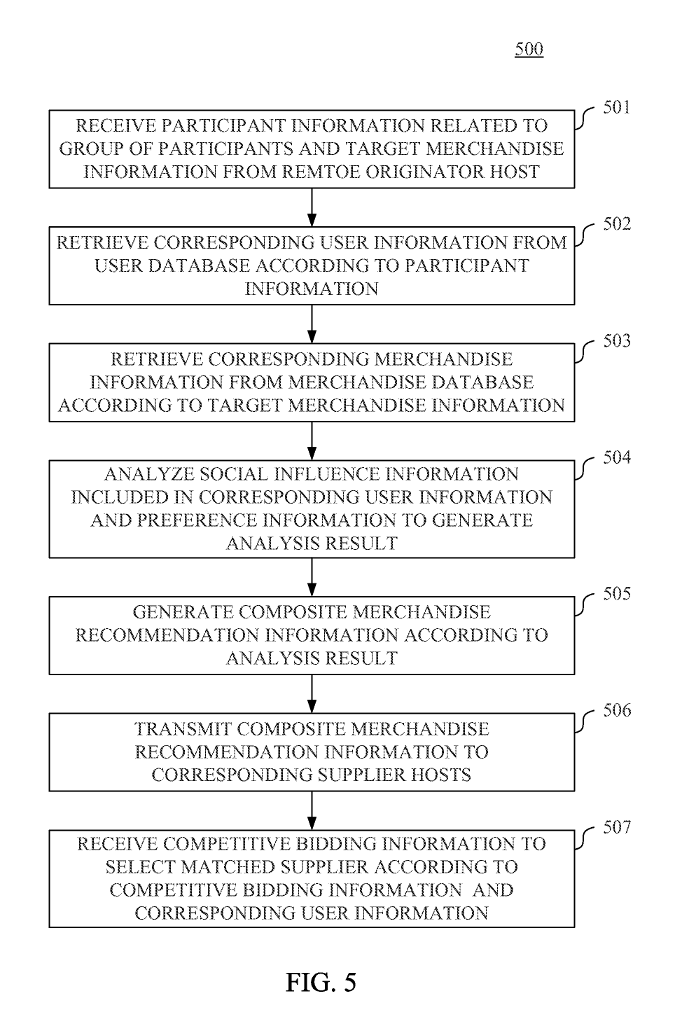

FIG. 5 is a flow chart of a merchandise recommendation method 500 in an embodiment of the present invention. The merchandise recommendation method 500 can be used in the merchandise recommendation system 1 depicted in FIG. 1. More specifically, the merchandise recommendation method 500 is implemented by using a computer program to control the modules in the merchandise recommendation system 1. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The merchandise recommendation method 500 comprises the steps outlined below. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 501, the processing module 106 receives participant information 131 related to a group of participants and a piece of target merchandise information 133 from a remote originator host 130 through the data transmission module 104.

In step 502, the processing module 106 retrieves a plurality of pieces of corresponding user information 107 from the user database 100 according to the participant information 131.

In step 503, the processing module 106 retrieves a plurality pieces of corresponding merchandise information 109 from the merchandise database 102 according to the target merchandise information 133.

In step 504, the processing module 106 analyzes social influence information included in the corresponding user information 107 and preference information related to the corresponding merchandise information 109 to generate an analysis result.

In step 505, the processing module 106 generates composite merchandise recommendation information 111 according to the analysis result.

In some embodiments, the processing module 106 selectively receives the suggestion information 303 and the editing information 301 to edit the composite merchandise recommendation information 111.

In step 506, the processing module 106 transmits the composite merchandise recommendation information 111 to the corresponding supplier hosts 402 and 404 through the data transmission module 104.

In step 507, the processing module 106 receives competitive bidding information 403 from the corresponding supplier hosts 402 and 404 through the data transmission module 104 to select a matched supplier according to the competitive bidding information 403 and the corresponding user information 107.

It is noted that the merchandises related to traveling are used as examples in the embodiments mentioned above. In other embodiments, the merchandise recommendation system, the method and the non-transitory computer readable storage medium of the same for multiple users can be applied to other kinds of composite merchandises.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A merchandise recommendation system comprising:
a user database for storing a plurality pieces of user information;
a merchandise database for storing a plurality pieces of merchandise information;
a data transmission module;
a processing module coupled to the user database, the merchandise database and the data transmission module; and
a memory for storing a plurality computer-executable commands and coupled to the processing module, wherein when the commands are executed by the processing module, the processing module performs the following steps:
receiving a piece of participant information related to a group of participants and a piece of target merchandise information from a remote originator host through the data transmission module;
retrieving a plurality of pieces of corresponding user information from the user database according to the participant information;
retrieving a plurality pieces of corresponding merchandise information from the merchandise database according to the target merchandise information;
analyzing a piece of social influence information comprised in the corresponding user information and a piece of preference information related to the corresponding merchandise information to generate an analysis result; and
generating a piece of composite merchandise recommendation information according to the analysis result.

2. The merchandise recommendation system of claim 1, wherein the processing module further transmits the composite merchandise recommendation information to a plurality of remote participant hosts corresponding to the group of participants through the data transmission module.

3. The merchandise recommendation system of claim 1, wherein the processing module further receives a piece of editing information from one of a plurality of remote participant hosts corresponding to the group of participants through the data transmission module to edit the composite merchandise recommendation information.

4. The merchandise recommendation system of claim 1, wherein the processing module further receives a piece of application information from at least one remote non-participant host corresponding to a user not in the group of participants through the data transmission module.

5. The merchandise recommendation system of claim 1, wherein the processing module further receives a piece of suggestion information from at least one remote non-participant host corresponding to a user not in the group of participants through the data transmission module and transmits the suggestion information to a plurality of remote participant hosts corresponding to the group of participants through the data transmission module.

6. The merchandise recommendation system of claim 1, further comprising a social network database, wherein the processing module further retrieves a piece of suggestion information from the social network database and transmits the suggestion information to a plurality of remote participant hosts corresponding to the group of participants through the data transmission module.

7. The merchandise recommendation system of claim 1, further comprising a supplier database, wherein the processing module further retrieves at least one piece of corresponding supplier information from the supplier database according to the composite merchandise recommendation information.

8. The merchandise recommendation system of claim 7, wherein the processing module further transmits the composite merchandise recommendation information to at least one corresponding supplier host through the data transmission module according to the corresponding supplier information.

9. The merchandise recommendation system of claim 8, wherein the processing module further receives a piece of competitive bidding information from the corresponding supplier host through the data transmission module and selects a matched supplier according to the competitive bidding information and the corresponding user information.

10. The merchandise recommendation system of claim 1, wherein the merchandise information comprises a piece of sightseeing spot information, a piece of traffic information, a piece of board and lodging information or a combination of the above.

11. The merchandise recommendation system of claim 1, wherein the processing module further analyzes the social influence information to calculate an influence weighting parameter according to a ranking relation, a social relation or a combination of the above, analyzes the preference information to calculates a preference value of each of the corresponding merchandise information and further calculates a weighted preference value of each of the corresponding merchandise information according to the influence weighting parameter and preference value to generate the composite merchandise recommendation information according to the weighted preference value.

12. A merchandise recommendation method used in a merchandise recommendation system comprising a user database, a merchandise database, a data transmission module, a processing module and a memory, wherein the processing module is coupled to the user database, the merchandise database, the data transmission module, the processing module and the memory, the merchandise recommendation method comprises:
receiving a piece of participant information related to a group of participants and a piece of target merchandise information from a remote originator host through the data transmission module by the processing module;
retrieving a plurality of pieces of corresponding user information from the user database according to the participant information by the processing module;
retrieving a plurality pieces of corresponding merchandise information from the merchandise database according to the target merchandise information by the processing module;
analyzing a piece of social influence information comprised in the corresponding user information and a piece of preference information related to the corresponding merchandise information to generate an analysis result by the processing module; and
generating a piece of composite merchandise recommendation information according to the analysis result by the processing module.

13. The merchandise recommendation method of claim 12, further comprising:
transmits the composite merchandise recommendation information to a plurality of remote participant hosts corresponding to the group of participants through the data transmission module by the processing module.

14. The merchandise recommendation method of claim 12, further comprising:
receiving a piece of editing information from one of a plurality of remote participant hosts corresponding to the group of participants through the data transmission module by the processing module; and
editing the composite merchandise recommendation information according to the editing information by the processing module.

15. The merchandise recommendation method of claim 12, further comprising:
receiving a piece of application information from at least one remote non-participant host corresponding to a user not in the group of participants through the data transmission module by the processing module.

16. The merchandise recommendation method of claim 12, further comprising:
receiving a piece of suggestion information from at least one remote non-participant host corresponding to a user not in the group of participants through the data transmission module by the processing module; and
transmitting the suggestion information to a plurality of remote participant hosts corresponding to the group of participants through the data transmission module by the processing module.

17. The merchandise recommendation method of claim 12, further comprising:
retrieving a piece of suggestion information from a social network database comprised by the merchandise recommendation system by the processing module; and
transmitting the suggestion information to a plurality of remote participant hosts corresponding to the group of participants through the data transmission module by the processing module.

18. The merchandise recommendation method of claim 12, further comprising:
retrieving at least one piece of corresponding supplier information from a supplier database comprised by the merchandise recommendation system according to the composite merchandise recommendation information by the processing module.

19. The merchandise recommendation method of claim 18, further comprising:
transmitting the composite merchandise recommendation information to at least one corresponding supplier host through the data transmission module according to the corresponding supplier information by the processing module.

20. The merchandise recommendation method of claim 19, further comprising:
receiving a piece of competitive bidding information from the corresponding supplier host through the data transmission module by the processing module; and
selecting a matched supplier according to the competitive bidding information and the corresponding user information by the processing module.

21. The merchandise recommendation method of claim 12, wherein the merchandise information includes a piece of sightseeing spot information, a piece of traffic information, a piece of board and lodging information or a combination of the above.

22. The merchandise recommendation method of claim 12, further comprising:
analyzing the social influence information to calculate an influence weighting parameter according to a ranking relation, a social relation or a combination of the above by the processing module;
analyzes the preference information to calculates a preference value of each of the corresponding merchandise information; and
calculating a weighted preference value of each of the corresponding merchandise information according to the influence weighting parameter and preference value to generate the composite merchandise recommendation information according to the weighted preference value.

23. A non-transitory computer readable storage medium to store a computer program to execute a merchandise recommendation method used in a merchandise recommendation system comprising a user database, a merchandise database, a data transmission module, a processing module and a memory, wherein the processing module is coupled to the user database, the merchandise database, the data transmission module, the processing module and the memory, the merchandise recommendation method comprises:
receiving a piece of participant information related to a group of participants and a piece of target merchandise information from a remote originator host through the data transmission module by the processing module;
retrieving a plurality of pieces of corresponding user information from the user database according to the participant information by the processing module;
retrieving a plurality pieces of corresponding merchandise information from the merchandise database according to the target merchandise information by the processing module;
analyzing a piece of social influence information comprised in the corresponding user information and a piece of preference information related to the corresponding merchandise information to generate an analysis result by the processing module; and
generating composite merchandise recommendation information according to the analysis result by the processing module.
